(19) United States
(12) Patent Application Publication
(10) Pub. No.: US 2025/0326497 A1
(43) Pub. Date: Oct. 23, 2025

(54) SYSTEMS AND METHODS FOR A DETERMINATION OF A LOCATION OF AN AERIAL REFUELING DROGUE USING ACTIVE ILLUMINATION

(71) Applicant: THE BOEING COMPANY, Arlington, VA (US)

(72) Inventors: Ryan P. McClintock, Brentwood, MO (US); Caleb G. Price, Brentwood, MO (US); Christian Louis Carini, St. Louis, MO (US)

(21) Appl. No.: 18/806,820

(22) Filed: Aug. 16, 2024

Related U.S. Application Data
(60) Provisional application No. 63/637,682, filed on Apr. 23, 2024.

(51) Int. Cl. B64D 39/04; G06T 1/00; G06T 7/11; G06V 10/60; G06V 20/56

(52) U.S. Cl. CPC B64D 39/04; G06T 1/0007; G06T 7/11; G06V 10/60; G06V 20/56; G06V 2201/07

(57) ABSTRACT

This disclosure provides systems, methods, and devices for performing image-based identification, such as identification of a location of an object. In some aspects, a device includes an imaging system and a vision processor. The imaging system includes an imaging sensor, a light source, and a filter. The imaging sensor is configured to generate an image that depicts at least a portion of an object that includes multiple reflective markers. The light source is configured to project light. The filter is positioned in a field of view of the imaging sensor and configured to pass at least a portion of the light reflected by at least one of the multiple reflective markers. The vision processor is configured to receive the image captured during projection of the light from the light source, and determine an estimate of a location of the object based on the image.

### CROSS-REFERENCE TO RELATED APPLICATIONS

The present application claims the benefit of U.S. Provisional Patent Application No. 63/637,682 entitled “SYSTEMS AND METHODS FOR A DETERMINATION OF A LOCATION OF AN AERIAL REFUELING DROGUE USING ACTIVE ILLUMINATION,” filed Apr. 23, 2024, the contents of which are incorporated by reference in their entirety.

### FIELD OF THE DISCLOSURE

The present disclosure is generally related to identification of a location of an object, such as a drogue, such as real-time location of an aerial refueling drogue.

### BACKGROUND

Highly skilled human operators are typically used to guide complex, high-speed docking operations, such as air-to-air refueling and spacecraft docking operations. As such, the operations rely heavily on human judgment, which is sometimes supplemented by computer vision techniques. To illustrate, complex stereoscopic vision systems may be used to aid the human operator in mating connectors (e.g., a receiver and refueling boom or docking connectors). However, in some circumstances, such as at high altitudes (e.g., at or above 25,000 feet) and during full daylight, solar interference caused by sunlight may reduce or diminish the effectiveness of one or more techniques employed by the vision systems. These docking operations can be complex and can involve precision maneuvers, making such operations difficult to extend to autonomous vehicles such as drones, drone aircraft, or autonomous spacecraft. Additionally, artificial intelligence-based solutions can be challenging to test, resulting in difficulty certifying such systems with industry organizations or governments.

### SUMMARY

In an aspect, a device includes an imaging system and a vision processor. The imaging system includes an imaging sensor, a light source, and a filter. The imaging sensor is configured to generate one or more images that each depict at least a portion of an object that includes multiple reflective markers. The light source is configured to project light. The filter is positioned in a field of view of the imaging sensor and configured to pass at least a portion of the light projected by the light source and reflected by the multiple reflective markers. The vision processor is configured to: receive a first image of the one or more images, the first image captured during projection of the light from the light source; and determine an estimate of a location of the object based on the first image.

In another aspect, a method includes projecting light from a light source towards an object that includes multiple reflective markers. The method also includes capturing, during projection of the light and using an imaging sensor having a filter positioned in a field of view of the imaging sensor, an image that depicts at least a portion of the object. The filter configured to pass at least a portion of the light projected by the light source and reflected by at least one of the multiple reflective markers. The method further includes determining an estimate of a location of the object based on the first image.

In another aspect, a non-transitory, computer-readable medium stores instructions that, when executed by one or more processors, cause the one or more processors to perform operations including initiating projection of light from a light source towards an object that includes multiple reflective markers. The operations also include initiating an image capture operation, during projection of the light and by an imaging sensor having a filter positioned in a field of view of the imaging sensor, of an image that depicts at least a portion of the object. The filter is configured to pass at least a portion of the light projected by the light source and reflected by the multiple reflective markers. The operations further include determining an estimate of a location of the object based on the first image.

In another aspect, a device includes a vision processor configured to receive an image captured by an imaging sensor during projection of the light from a light source towards an object that includes multiple reflective markers. The image depicts at least a portion of the object. The imaging sensor has a filter positioned in a field of view of the imaging sensor. The filter is configured to pass at least a portion of the light projected by the light source and reflected by at least one of the multiple reflective markers. The vision processor is further configured to determine an estimate of a location of the object based on the image.

In another aspect, a method includes receiving an image captured by an imaging sensor during projection of the light from a light source towards an object that includes multiple reflective markers. The image depicts at least a portion of the object. The imaging sensor has a filter positioned in a field of view of the imaging sensor. The filter is configured to pass at least a portion of the light projected by the light source and reflected by at least one of the multiple reflective markers. The method also includes determining an estimate of a location of the object based on the image.

In another aspect, a non-transitory, computer-readable medium stores instructions that, when executed by one or more processors, cause the one or more processors to perform operations including receiving an image captured by an imaging sensor during projection of the light from a light source towards an object that includes multiple reflective markers. The image depicts at least a portion of the object. The imaging sensor has a filter positioned in a field of view of the imaging sensor. The filter is configured to pass at least a portion of the light projected by the light source and reflected by at least one of the multiple reflective markers. The operations further include determining an estimate of a location of the object based on the image.

The features, functions, and advantages described herein can be achieved independently in various implementations or may be combined in yet other implementations, further details of which can be found with reference to the following description and drawings.

### BRIEF DESCRIPTION OF THE DRAWINGS

FIGS. 1A-H illustrate examples of a system configured to identify a location of a drogue using active illumination according to one or more aspects of the present disclosure.

FIG. 2 is a diagram that illustrates an example of a system configured to identify a location of a drogue using active illumination according to one or more aspects of the present disclosure.

FIG. 3 depicts an example of a technique to generate a threshold image according to one or more aspects of the present disclosure.

FIG. 4 depicts an example of another technique to generate a threshold image according to one or more aspects of the present disclosure.

FIG. 5 depicts an example of a technique to identify a location of a drogue using active illumination according to one or more aspects of the present disclosure.

FIG. 6 depicts an example of a technique to use a model to identify a location of a drogue using active illumination according to one or more aspects of the present disclosure.

FIG. 7 is a diagram that illustrates a flow chart of an example of a method of identifying a location of an object using active illumination according to one or more aspects of the present disclosure.

FIG. 8 is a flowchart illustrating an example of a life cycle of an aircraft including a vision system configured to identify a location of an object using active illumination according to one or more aspects of the present disclosure.

FIG. 9 is a block diagram of a particular implementation of the aircraft associated with the life cycle of FIG. 8 according to one or more aspects of the present disclosure.

FIG. 10 is a block diagram of a computing environment including a computing device configured to support aspects of computer-implemented methods and computer-executable program instructions (or code) according to one or more aspects of the present disclosure.

### DETAILED DESCRIPTION

Aspects disclosed herein present systems and methods of image-based detection of a location or an estimated location of a connector of a vehicle to be mated with a connector of an autonomous or semi-autonomous vehicle using active illumination. For example, a vision processor that resides onboard a first aircraft, such as a drone aircraft, another type of autonomous aircraft or semi-autonomous aircraft (e.g., an aircraft that implements an autonomous aerial refueling receive (A2R2) capability), or an autonomous or semi-autonomous spacecraft, can process image data from an imaging sensor, such as an infrared camera, to detect or identify a second connector of a second aircraft depicted in the image data. To illustrate, the imaging sensor can perform an image capture operation to generate the image data while a light source projects light toward an object in a field of view of the imaging sensor. Additionally, a filter is positioned in a field of view of the imaging sensor and configured to pass at least a portion of the light projected by the light source. The second aircraft can include an aircraft, another autonomous or semi-autonomous aircraft, or an autonomous or semi-autonomous spacecraft, such as a refueling tanker, that includes the second connector with which a first connector of the first aircraft is configured to mate.

In implementations described herein, the first connector includes a probe, a fuel receptacle, a docking appendage, or the like, and the second connector includes an object, such as a drogue basket (e.g., a drogue or a basket), a refueling boom, a docking clamp or receptacle, a socket, or the like, that is attached to the second aircraft. The second connector can include one or more reflective markers, such as one or more retroreflective markers. In some implementations, the vision processor processes the image data and outputs an indication of a location or an estimated location of the second connector (or a portion thereof) to one or more other processor(s), such as a guidance processor of a navigation system, to enable the guidance processor to determine and initiate the performance of maneuvers to guide the first aircraft to mate the first connector (e.g., the probe) to the second connector (e.g., the drogue basket). As an example, the location and/or the estimated location output by the vision processor can enable the guidance processor to maneuver the first aircraft such that a refueling connector (e.g., the probe) is mated to a refueling port (e.g., the drogue) of the second aircraft during air-to-air refueling operations. As another example, the location or the estimated location output by the vision processor can enable the guidance processor to maneuver the first aircraft such that one spacecraft is docked to another spacecraft (e.g., via mating the first and second connectors). In implementations, the vision processor is used to support the guidance processor instead of using a human operator to reduce costs, such as costs associated with training human operators and costs associated with operations to mate connectors.

In some contexts, the two aircraft performing mating (e.g., of connectors) include a primary aircraft and a secondary aircraft. Although the terms may be arbitrarily assigned in some contexts (such as where two peer aircraft are mating), generally, the primary aircraft refers to an aircraft that is connecting to the secondary aircraft to be serviced by the secondary aircraft, or the primary aircraft refers to the aircraft, onboard which the vision processor resides. To illustrate, in an air-to-air refueling context, the primary aircraft is the receiving aircraft (e.g., the aircraft to be refueled). Likewise, the secondary aircraft refers to the other aircraft of a pair of aircraft. To illustrate, in the air-to-air refueling context, the secondary aircraft is the tanker aircraft. Although predominately referred to herein as aircraft, the first aircraft and the second aircraft can also be referred to as a first device and a second device, with the term device used broadly to include an object, system, or assembly of components that is/are operated upon as a unit (e.g., in the case of the secondary device) or that operate cooperatively to achieve a task (e.g., in the case of the primary device).

In a particular aspect, the first aircraft includes an imaging system and a vision processor. The imaging system includes an imaging sensor, a light source, and a filter. The imaging sensor, such as a camera, is configured to generate one or more images that each depict at least a portion of a drogue that is attached to a second aircraft and includes multiple reflective markers. The multiple reflective markers may be positioned on a canopy of the drogue, and at least one reflective marker of the multiple reflective markers can be a retroreflector. The light source, such as a high-intensity light source, a high-speed light source, a narrow-band light source, or a combination thereof, is configured to project light. In some implementations, the light source includes multiple infrared light emitting diodes (LEDs) or a laser. Additionally, in some implementations, projection of the light by the light source is time-correlated with operation of a shutter of the imaging sensor (e.g., the camera). The filter is positioned in a field of view of the imaging sensor and configured to pass at least a portion of the light projected by the light source and reflected by the multiple reflective markers. In some implementations, the filter is configured to block light other than the light projected by the light source.

In some implementations, the imaging sensor is configured to capture a first image of the one or more images during projection of the light from the light source. The imaging sensor can provide the first image to the vision processor and the vision processor can process the first image to determine an estimate of a location (e.g., a center) of the drogue based on the first image. The imaging system (e.g., the imaging sensor, the light source, and the filter), the processing of the first image by the vision processor, or both, is configured to minimize solar interference in the first image and enable identification of the drogue and/or a location of the drogue.

In some implementations, the vision processor is configured to generate a thresholded image based on the first image. For example, the vision processor can perform a thresholding operation on the first image to generate a thresholded image. As another example, the vision processor can determine a difference between the first image and a second image to generate a difference image, and perform thresholding operation on the difference image to generate the thresholded image. To illustrate, the vision processor can activate the light source concurrently with initiation of a first image capture operation by the imaging sensor to capture the first image, and the vision processor can initiate a second image capture operation by the imaging sensor to capture, while the light source is deactivated, a second image of the one or more images. The vision processor then can perform a correlation operation, such as a correlated double sampling operation, based on the first image and the second image to generate the difference image. In some aspects, a difference indicated by the difference image can correspond to one or more reflective markers of the drogue being illuminated based on the light projected by the light source during capture of the first image (and the light not being projected by the light source during capture of the second image). In some aspects, the order of the first and second image can be reversed, such that the first image is captured with the light source deactivated and the second image is captured with the light source activated.

In some implementations, the vision processor is further configured to perform a blob segregation operation on the thresholded image to identify multiple blobs and/or a location of each blob of the multiple blobs. Based on the multiple blobs, the vision processor can identify a center of the multiple blobs, fit a model to the multiple blobs, or a combination thereof. The vision processor can determine the location of the drogue based on the center of the multiple blobs, the model, or a combination thereof. In some implementations, the vision processor is further configured to generate a score associated with the location of the drogue. Additionally, or alternatively, the vision processor can adjust an exposure time of the imaging sensor, a sensor gain (e.g., ISO sensitivity), an illumination intensity of the light source, a synchronization between the imaging sensor and the light source, or a combination thereof.

One benefit of the disclosed systems and methods is that the vision processor and the thermal imaging sensor provide an all-optical, passive solution for detection of the second connector and mating, during flight, of the first connector of an autonomous or semi-autonomous vehicle with the second connector. For example, by leveraging the reflective markers positioned on a front of a skirt or canopy of the second connector, a vision system can be configured to project light that is reflected by the multiple reflective markers and captured by the imaging sensor via the filter. Additionally, the vision processor described in aspects herein can process images to detect the multiple reflective marks and identify a location of the second connector or a portion thereof, such as a socket of the second connector to be connected to the first connector. Additionally, the systems and methods disclosed herein can provide autonomous mating of connectors between aircraft without significantly increasing cost or complexity of the systems onboard the autonomous aircraft. Additionally, or alternatively, the vision processor can provide a real-time location or estimated location of the second connector. Further, using vision-based maneuvering to control autonomous aircraft or spacecraft during complicated maneuvers, such as aerial refueling or docking, can reduce costs and resources as compared to training human operators to control the aircraft, as well as providing more predictable and repeatable maneuvers than using human operators.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, a system may be described herein as including one or more computing devices (“computing device(s)”), which indicates that in some implementations the system includes a single computing device and in other implementations the system includes multiple computing devices. For ease of reference herein, such features are generally introduced as “one or more” features, and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “obtaining,” “generating,” “calculating,” “using,” “selecting,” “accessing,” and “determining” are interchangeable unless context indicates otherwise. For example, “obtaining,” “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise.

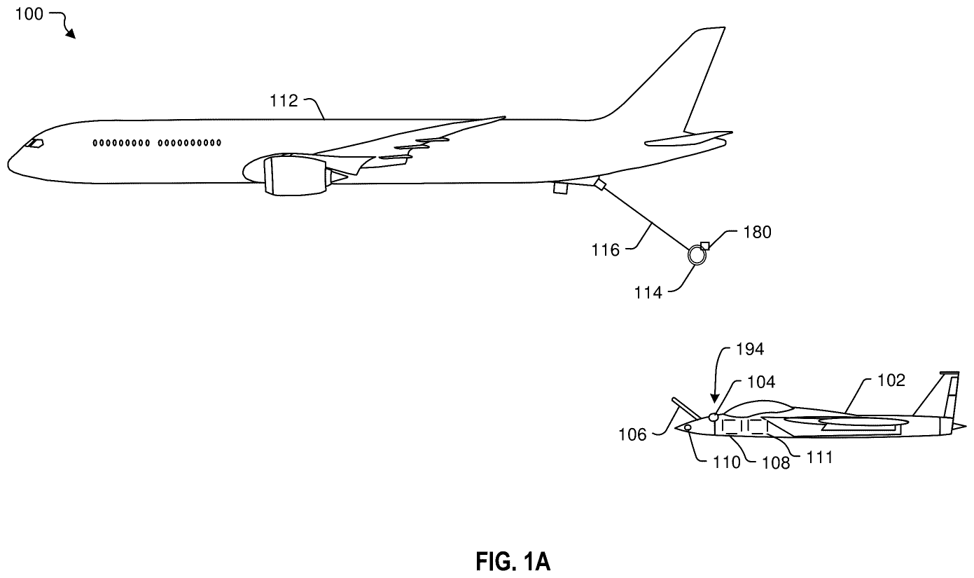

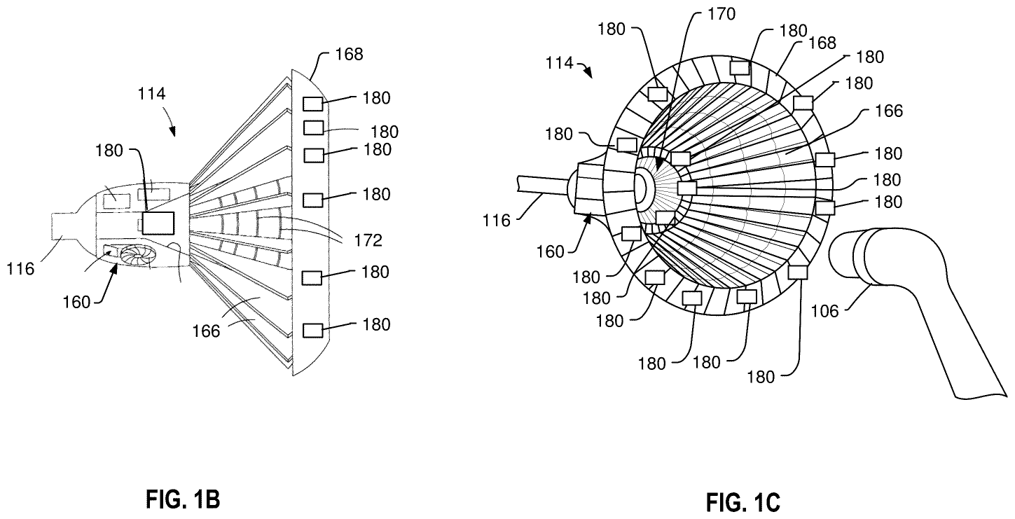

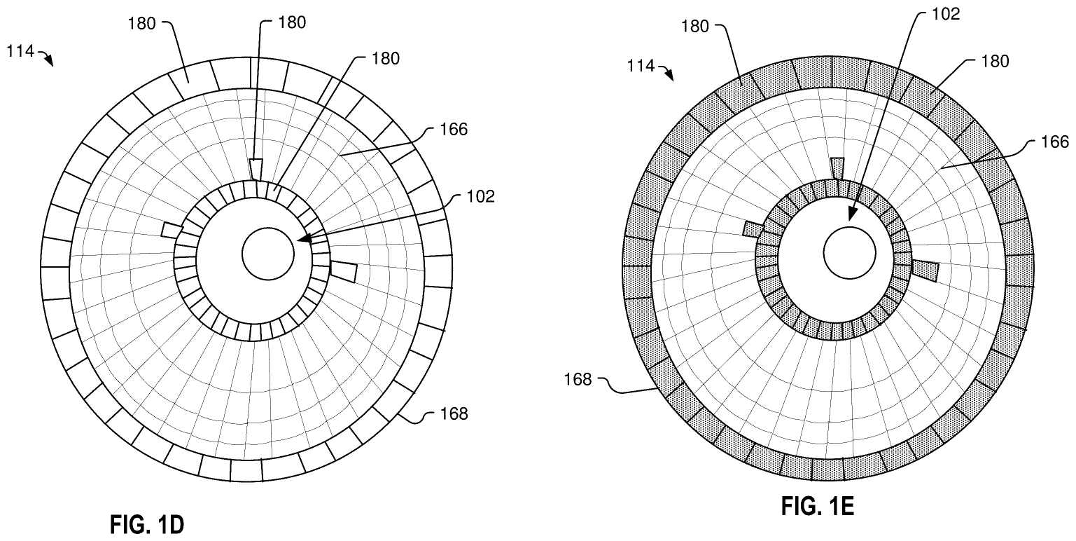

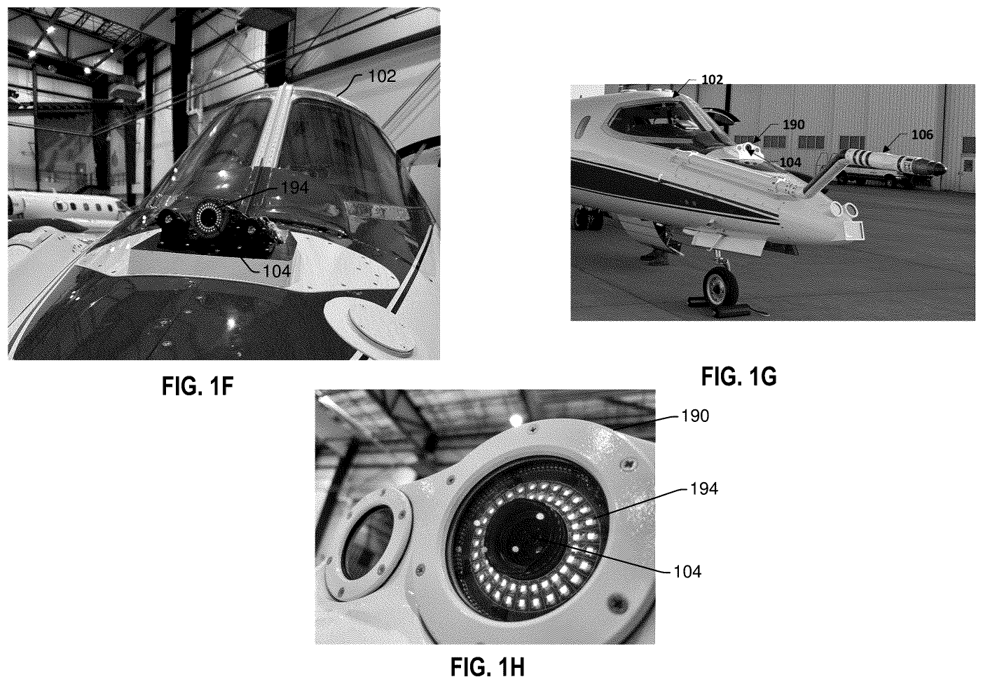

FIGS. 1A-H illustrate examples of a system 100 for identifying a location of a drogue according to one or more aspects of the present disclosure. Although described with reference to identifying a location of a drogue, one or more techniques described herein with respect to identifying a location of a drogue may be used to identify a location of an object.

FIG. 1A is a diagram that illustrates the system 100 including several aircraft including a first aircraft 102 and a second aircraft 112. FIG. 1B is a diagram of a side-view of an example of a drogue 114 of the second aircraft 112. FIG. 1C is a diagram of an example of the drogue 114 and a probe 106 of the first aircraft 102. FIG. 1D is a front view of the drogue 114 that is not actively illuminated and FIG. 1E is a front view of the drogue 114 that is actively illuminated. FIGS. 1F and 1G are each an image of an example of the first aircraft 102, and FIG. 1H is an image of an assembly 190 of the first aircraft 102.

Referring to FIG. 1A, the system 100 includes the first aircraft 102 and the second aircraft 112. The first aircraft 102 is configured to identify or estimate a location of a drogue 114 (e.g., a basket) attached to the second aircraft 112. For example, the first aircraft 102 can detect or estimate a location of the drogue 114 based on image data. Detection or estimation of the location of the drogue 114 can enable the first aircraft 102 to identify or track the drogue 114. In some implementations, detection of the location of the drogue 114 can enable the first aircraft 102 to perform one or more maneuvers to mate the probe 106 (also referred to as a first connector) of the first aircraft 102 with the drogue 114, also referred to as a second connector, of the second aircraft 112.

In the example illustrated in FIG. 1A, the first aircraft 102 includes or corresponds to an autonomous aircraft, such as a drone or drone aircraft, a semi-autonomous aircraft (e.g., an aircraft that supports an A2R2 capability), an autonomous or semi-autonomous spacecraft, or the like (a primary device, as described above), and the second aircraft 112 includes or corresponds to a fuel tanker (a secondary device, as described above). For example, the second aircraft 112 can be configured to service or support the first aircraft 102, such as providing fuel or a refueling service, and the first aircraft 102 includes a device or system configured to couple to the second aircraft 112 and possibly to be serviced by or supported by the second aircraft 112. Although described in the context of a fuel tanker and an autonomous or semi-autonomous aircraft, in other implementations, the first aircraft 102 can include other types of aircraft or spacecraft, such as a space shuttle, and the second aircraft 112 can include other types of aircraft of spacecraft, such as a space station with which the first aircraft 102 is configured to dock.

The second aircraft 112 is coupled via a hose 116 to the drogue 114. The first aircraft 102 includes the probe 106 that is configured to couple with (e.g., physically attach to) the drogue 114. The second aircraft 112 is configured to provide fuel via the hose 116 to the first aircraft 102 while the probe 106 is coupled to the drogue 114. Although the drogue 114 is illustrated in FIG. 1A as being coupled to the second aircraft 112 via the hose 116, in some other implementations, the second aircraft 112 includes a moveable coupling system configured to move the drogue 114 (or another type of connector) relative to the probe 106 (or another type of connector) of the first aircraft 102. For example, the moveable coupling system of the second aircraft 112 can include a steerable boom (e.g., a refueling boom) of a refueling system or a steerable docking arm of a docking system. The above referenced examples are merely illustrative and are not limiting. Additionally, the second aircraft 112 includes a fuel tank to supply fuel, via the hose 116 (or a refueling boom), to the first aircraft 102.

Referring to FIGS. 1B-1E, the drogue 114 includes a reception coupling 160 and an array of structures 166 (also referred to herein as arms or spokes) extending therefrom and which support a canopy 168 at the distal ends thereof. The reception coupling 160 includes an internal passage 170 (e.g., a socket) for receiving a refueling probe (e.g., the probe 106) and is attached to a fuel hose (e.g., the hose 116). The structures 166 surround the entrance to the internal passage 170 and may each be joined to adjacent arms by couplings 172 (e.g., tie ropes, wires, or other material) for avoiding penetration between the structures 166 by the probe 106. The structures 166 can each have a planar (or substantially planar) body portion, extending radially from an opening/center of the internal passage 170 (e.g., the socket) the drogue 114.

The drogue 114 also includes one or more reflective markers 180. The reflective markers 180 can include reflective fabric or reflective tape, as illustrative, non-limiting examples. Additionally, reflective markers 180 can include retroreflective markers. To illustrate, a retroreflective marker is configured to receive light (e.g., a light beam) from a light source and direct a portion (e.g., a large portion) of the light beam back to the light source. For example, a retroreflector device or surface is configured to reflect radiation (e.g., light) back to the source of the radiation with a minimum of scattering. With respect to FIG. 1E, FIG. 1E is a front view of the drogue 114 that is actively illuminated such that the reflective markers 180 reflect (as indicated by the cross-hatching of reflective surfaces of the reflective markers 180) a portion of light received from a light source. The reflective light can be referred to as a reflected signal (e.g., a retroreflected signal). The reflective markers 180 are coupled to the drogue 114 and can include a single reflective marker or multiple discrete reflective markers. For example, the reflective markers 180 can be coupled to the reception coupling 160, the structures 166, the canopy 168, the socket, or a combination thereof. In some implementations, the reflective markers 180 are intrinsic to the drogue 114.

Referring to FIGS. 1A, 1F, 1G, and 1H, the first aircraft 102 includes an imaging sensor 104 (e.g., a camera) and a light source 194. In an example, the imaging sensor 104 can be configured to generate image data (e.g., image(s)) that depicts at least a portion of the second aircraft 112 or objects attached thereto, such as at least a portion of drogue 114. In some implementations, the image data represents a stream of real-time (e.g., subject to only minor video front-end processing delays and buffering) image frames that represent relative positions of at least a portion of the drogue 114, at least a portion of the second aircraft 112, or a combination thereof. In a particular aspect, the imaging sensor 104 is located within a housing (e.g., the assembly 190) that is coupled to a hull of the first aircraft 102 and that includes an aperture that provides a field of view for the imaging sensor 104. Alternatively, the imaging sensor 104 can be located at or near an end of the probe 106. In some implementations, the first aircraft 102 includes multiple imaging sensors 104 positioned at one or more locations with respect to the hull of the first aircraft 102, the probe 106, or a combination thereof.

The light source 194 is configured to project light. For example, the light source 194 can be a high-intensity light source, a high-speed light source, a narrow-band light source, or a combination thereof. In some implementations, the light source 194 is configured to operate as a strobe light. In some implementations, the light source 194 is an infrared light emitting diode (LED), such as an infrared LED ring-light. The light source 194 can include an infrared emitter, such as a LUXEON IR Domed Line high power infrared emitter produced by LUMILEDS™. In other implementations, the light source 194 is a laser source, such as a pulsed laser source. As an illustrative, non-limiting example, the light source 194 can be configured to emit light at or substantially at 850 nm. It is noted that any wavelength that can be detected by the imaging sensor 104 can be used as light projected by the light source 194.

The imaging sensor 104 and the light source 194 can be collocated. For example, the imaging sensor 104 can be positioned at the center of the light source 194—which can be an LED ring-light. Additionally, or alternatively, the imaging sensor 104 and the light source 194 can be configured for synchronous operation. For example, a synchronization (sync) signal can be provided to each of the imaging sensor 104 and the light source 194 to time-correlate operation of a shutter (e.g., a camera shutter) of the imaging sensor 104 and operation/activation of the light source 194. To illustrate, the imaging sensor 104 can generate and transmit the sync signal to the light source 194 to synchronize operation of the shutter of the imaging sensor 104 and an output (e.g., a strobe output) of the light source 194. Alternatively, the vision processor 108 can generate and transmit the sync signal to the imaging sensor 104 and the light source 194 to synchronize (simultaneously trigger) operation of the shutter of the imaging sensor 104 and an output (e.g., a strobe output) of the light source 194. In response to the sync signal, the light source 194 can provide a short (very short), high-intensity period of illumination that is directed in the same direction as a field of view of the imaging sensor 104. In some implementations, the sync signal can be provided such that the light source 194 projects light in a strobe manner—e.g., the light source 194 alternates between an active state (an illumination state) and an inactive state (a non-illumination state). The imaging sensor 104 can be configured to capture images while the light source 194 is in the active state and/or the inactive state. Accordingly, the imaging sensor 104 can be configured to perform a series of image capture operations that alternate between a first image capture operation to capture an illuminated image while the light source 194 is activated, and a second image capture operation to capture a non-illuminated image while the light source 194 is deactivated.

In some implementations, the sync signal is a high-speed sync (HSS) which enables the light source 194 to project light (e.g., flash) along with a shutter speed that is faster than or equal to 1/200 of a second. Additionally, a very short exposure time—e.g., a fast shutter speed—can minimize solar interference.

In some implementations, a filter (not shown in FIGS. 1A-H) is positioned in front of the imaging sensor 104. For example, the filter can be positioned in a field of view of the imaging sensor 104. The filter can be configured as a narrow band-pass filter. As an illustrative, non-limiting example, the filter is a narrow-band filter with an 850 nm+/−10 nm bandpass. Additionally, or alternatively, the filter can be configured to pass at least a portion or an entirety of the light emitted from the light source 194 and/or to block light other than the light emitted from the light source 194. To illustrate, the light source 194 can project light that is reflected by the reflective markers 180 and received by the imaging sensor 104 via the filter while the filter blocks light illuminated from other sources. The combination of the imaging sensor 104, the light source 194, and the filter, when used in conjunction with the reflective markers 180, can reduce or eliminate solar interference. For example, to minimize collected solar interference in an image, the light source 194 can project light that has a narrow-band, is wavelength-matched to the band-pass filter, and/or that is synchronous with an exposure time to the imaging sensor 104.

Referring to FIG. 1A, the first aircraft 102 also includes a vision processor 108, an optional memory (not shown in FIGS. 1A-H), one or more additional processors 111, and optionally, one or more sensors 110. In the example illustrated in FIGS. 1A-H, the vision processor 108 includes or corresponds to one or more image processors. The vision processor 108 may be configured to perform real-time processing of one or more images. In examples, the additional processor(s) 111 include or correspond to one or more guidance processors, one or more navigational processors, one or more processors of a flight control system, other types of processors, or a combination thereof. In some implementations, the vision processor 108 and the additional processor(s) 111 are combined. To illustrate, one or more GPUs, one or more central processing units (CPUs), one or more field programmable gate arrays (FPGAs), one or more digital signal processors (DSPs), or one or more other multi-core or multi-thread processing units may serve as both the vision processor 108 and the additional processor(s) 111. Although some implementations include the memory, in other implementations, the memory is omitted from the first aircraft 102.

The sensor(s) 110, when present, are configured to generate supplemental sensor data (e.g., additional image and/or position data) indicative of relative positions of the first aircraft 102 and the second aircraft 112. For example, the sensor(s) 110 may include a camera, a video capture device, thermal imaging sensor, a light source, a light emitting diode (LED) device, position sensors (e.g., gyroscope(s), accelerometer(s), inertial navigation system (INS) sensors, and the like), and sensor data generated by the sensor(s) 110 can include additional image data, video data, position data, such as 6 degrees of freedom (6DoF) position data, INS data, or a combination thereof. Additionally, or alternatively, the sensor(s) 110 may include a range finder (e.g., a laser range finder and/or a radio with ranging capability, such as a tactical radio), and the sensor data generated by the sensor(s) 110 can include range data (e.g., a distance from the range finder to the second aircraft 112). Additionally, or alternatively, the sensor(s) 110 may include a radar system, and the sensor data generated by the sensor(s) 110 may include radar data (e.g., radar returns indicating a distance to the second aircraft 112, a direction to the second aircraft 112, or both). Additionally, or alternatively, the sensor(s) 110 may include a light detection and ranging (lidar) system, and the sensor data generated by the sensor(s) 110 may include lidar data (e.g., lidar returns data indicating a distance to the second aircraft 112, a direction to the second aircraft 112, or both). Additionally, or alternatively, the sensor(s) 110 may include a sonar system, and the sensor data generated by the sensor(s) 110 may include sonar data (e.g., sonar returns indicating a distance to the second aircraft 112, a direction to the second aircraft 112, or both). Additionally, or alternatively, the sensor(s) 110 may include one or more additional cameras (e.g., in addition to the imaging sensor 104), and the sensor data generated by the sensor(s) 110 may include stereoscopic image data.

In some implementations, the sensor(s) 110 include a thermal imaging sensor, such as a long-wave infrared (LWIR) camera or another type of infrared (IR) camera. The thermal imaging sensor can be configured to generate thermal image data (e.g., thermal image(s)) that depicts temperature information associated with at least a portion of the second aircraft 112. For example, the LWIR camera can be configured to generate thermal image data based on wavelengths ranging from 8 μm to 14 μm. In some implementations, the thermal image data represents a stream of real-time (e.g., subject to only minor video front-end processing delays and buffering) thermal image frames that represent relative temperatures and relative positions of at least a portion of the drogue 114, at least a portion of the second aircraft 112, or a combination thereof. In a particular aspect, the thermal imaging sensor is located within a housing (e.g., the assembly 190) that is coupled to a hull of the first aircraft 102 and that includes an aperture that provides a field of view for a thermal imaging sensor. Alternatively, the thermal imaging sensor can be located at or near an end of the probe 106. In some implementations, the first aircraft 102 includes multiple thermal imaging sensors positioned at one or more locations with respect to the hull of the first aircraft 102, the probe 106, or a combination thereof.

During operation, the first aircraft 102 can activate the imaging sensor 104 to capture an image of at least a portion of the drogue 114, and optionally, at least a portion of the second aircraft 112. For example, the imaging sensor 104 can capture one or more images of the portion of the drogue 114. To illustrate, the imaging system can activate the light source 194 concurrently with initiation of a first image capture operation by the imaging sensor 104 to capture a first image via the filter, and the imaging system can initiate a second image capture operation by the imaging sensor 104 to capture, while the light source 194 is deactivated, a second image via the filter. In implementations that include the sensor(s) 110, the sensor(s) 110 can capture additional sensor data associated with the second aircraft 112, the drogue 114, or both.

The vision processor 108 processes the image data to detect a location (e.g., an estimated location) of the drogue 114, or a portion thereof. In some implementations, the vision processor 108 can perform a thresholding operation on the first image to generate a thresholded image. In some other implementations, the vision processor 108 can perform a correlated double sampling operation, based on the first image and the second image, to generate a difference image that is then thresholded to generate a thresholded image. The vision processor 108 can determine an estimate of a location (e.g., a center) of the drogue 114 based on the thresholded image.

The vision processor 108 provides information associated with the location or the estimated location of the drogue 114 to the additional processor(s) 111. In some implementations, the vision processor 108 processes the additional sensor data to detect a location (e.g., an estimated location) of the drogue 114, or a portion thereof, using other techniques and the additional sensor data, and the vision processor 108 provides information associated with the location or the estimated location detected based on the additional sensor data to the additional processor(s) 111. In this example, the vision processor 108 can provide scores (e.g., confidence scores) associated with the location, estimated location, or a combination thereof, to the additional processor(s) 111. The additional processor(s) 111 can determine navigation for the first aircraft 102 and/or maneuver the first aircraft 102, the probe 106, or both, based on the location and/or the estimated location, to engage the probe 106 with the drogue 114 to initiate refueling of the first aircraft 102.

Although FIGS. 1A-H depict the first aircraft 102 including the sensor(s) 110, in some implementations the sensor(s) 110 are omitted or are not used to generate input to the additional processor(s) 111. For example, a location and/or an estimated location (e.g., of the drogue 114 or a portion thereof) may be determined solely based on image data output by the imaging sensor 104. Additionally, or alternatively, the vision processor 108 can perform one or more additional operations to identify or track the second aircraft 112 and/or the drogue 114, such as by using the imaging sensor 104 and/or the sensor(s) 110.

The imaging sensor 104, the light source 194, the filter, and the vision processor 108, in conjunction with other features of the first aircraft 102, improves efficiency (e.g., by reducing training costs), reliability, and repeatability of operations to mate the probe 106 and the drogue 114. For example, the imaging system can leverage one or more reflective markers included in or affixed to the drogue 114 to capture an image using the imaging sensor 104. The imaging system can use a band-pass filter on the imaging sensor 104 having a narrow filter which matches a wavelength of the high-intensity, narrow-band, short-pulse light from the light source 194 to enable a captured image to include illuminated reflective markers 180. The contrast of the illuminated reflective markers 180 to the rest of the image may enable the vision processor 108 to process the image and determine the estimate location of the drogue 114 even in conditions at high altitudes when the sun (e.g., solar interference) is present. As another example, the vision processor 108 can process image data generated by the imaging sensor 104 to detect the location (e.g., the estimated location) of the drogue 114, or a portion thereof, without the cost and complexity of integrating other types of sensors in the first aircraft 102.

Additionally, or alternatively, the location or the estimated location detected by the vision processor 108 can be used to support operations or functionality of other systems of the first aircraft 102, thereby improving the reliability and increasing confidence in detection and/or identification of the drogue 114 or a portion thereof. Such highly reliable detection is provided without significantly increasing the cost or complexity of the first aircraft 102, as the imaging sensor 104, the light source 194, the filter, and the vision processor 108 represent a relatively small and low-cost portion of the overall processing resources and sensors onboard the first aircraft 102. The detection of the location of the drogue 114 or a portion thereof may be provided to the additional processor(s) 111, such as a guidance processor, which can mimic maneuvers performed by highly skilled human operators without the time and cost required to train the operators. Further, damage caused by improper maneuvers performed by automated aircraft or spacecraft can be reduced or eliminated by performing maneuvers that are determined based on the location or the estimated location of the drogue (or a portion thereof) output by the vision processor 108.

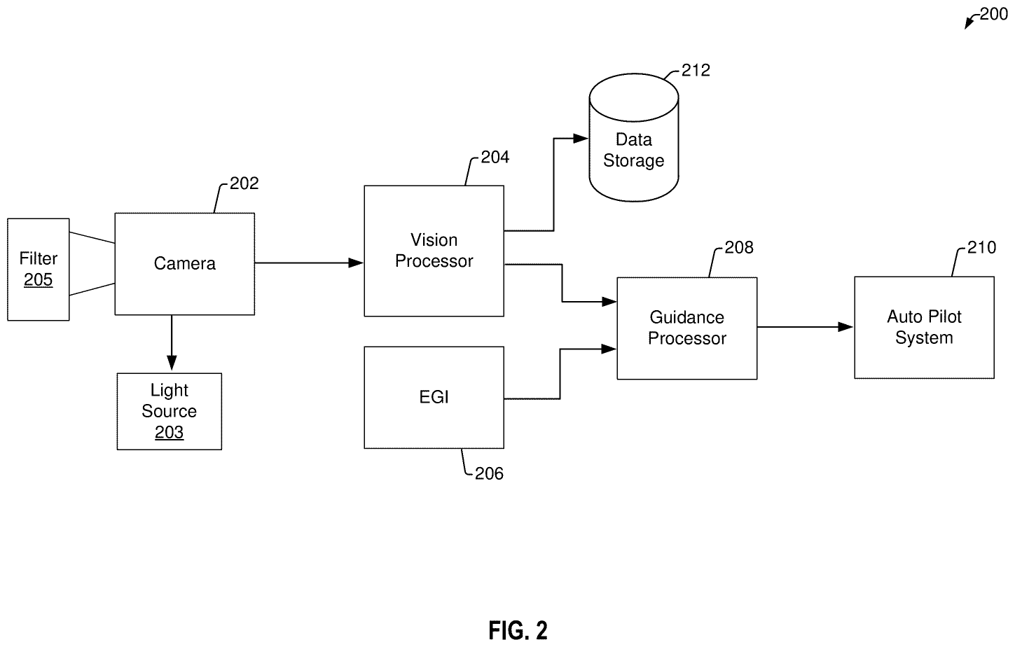

FIG. 2 is a diagram that illustrates a system 200 that is configured to identify a location of a drogue using active illumination according to one or more aspects of the present disclosure. The system 200 is included in one or more devices, such as an autonomous or semi-autonomous aircraft or spacecraft. As an example, the system 200 can be included in or correspond to the first aircraft 102 of FIGS. 1A, 1F, and 1G. In the implementation shown in FIG. 2, the system 200 includes a camera 202, a light source 203, a vision processor 204, a filter 205, an optional embedded GPS-aided inertial navigation system (EGI) 206, a guidance processor 208, an auto pilot system 210, and optional data storage 212. The camera 202 is coupled to the vision processor 204, the vision processor 204 is coupled to the guidance processor 208 and the data storage 212, the EGI 206 is coupled to the guidance processor 208, and the guidance processor 208 is coupled to the vision processor 204, the EGI 206, and the auto pilot system 210. Although illustrated as being included in the system 200 in FIG. 2, in some other implementations, the EGI 206 is omitted from the system 200. Although illustrated as being coupled to the camera 202, the light source 203 can be coupled to the vision processor 204.

The camera 202 can include or correspond to the imaging sensor 104. In some implementations, the camera 202 is configured to capture images within a field of vision and to output image data representing one or more of the images to the vision processor 204. The image data can depict information of a captured scene, such as a portion of another aircraft or spacecraft that is within a particular range of the aircraft on which the system 200 is onboard. Additionally, or alternatively, one or more other cameras, image capture devices, LED devices, or the like, may be similarly coupled to the vision processor 204 and configured to output respective image data or other types of data for use by the vision processor 204.

The light source 203 can include or correspond to the light source 194. As shown, the light source 203 is configured to receive a signal from the camera 202. For example, the signal can include a synchronization (sync) signal that is configured to time-correlate operation of a shutter (e.g., a camera shutter) of the camera 202 and operation/activation of the light source 194. In some implementations, the sync signal is a high-speed sync (HSS) which enables the light source 203 to project light (e.g., flash) along with a shutter speed that is faster than or equal to 1/200 of a second. In some implementations the vision processor 204 provides a sync signal to the camera 202 and the light source 203 directly rather than the camera 202 providing the sync signal to the light source 203.

The filter 205 is positioned in front of the camera 202. For example, the filter 205 can be positioned in a field of view of the camera 202. The filter 205 can be configured as a narrow band-pass filter. As an illustrative, non-limiting example, the filter 205 is a narrow-band filter with an 850 nm+/−10 nm bandpass. Additionally, or alternatively, the filter can be configured to pass at least a portion or an entirety of the light emitted from the light source 203 and/or to block light other than the light emitted from the light source 203. To illustrate, the light source 203 can project light that is reflected by the reflective markers 180 and received by the camera 202 via the filter 205 while blocking light from other light sources. The combination of the camera 202, the light source 203, and the filter 205, when used in conjunction with the reflective markers 180, can reduce or eliminate solar interference in the image data. For example, to minimize collected solar interference in an image, the light source 203 can project light that has a narrow-band, is wavelength-matched to the band-pass filter (e.g., 205), and/or that is synchronous with an exposure time of the camera 202.

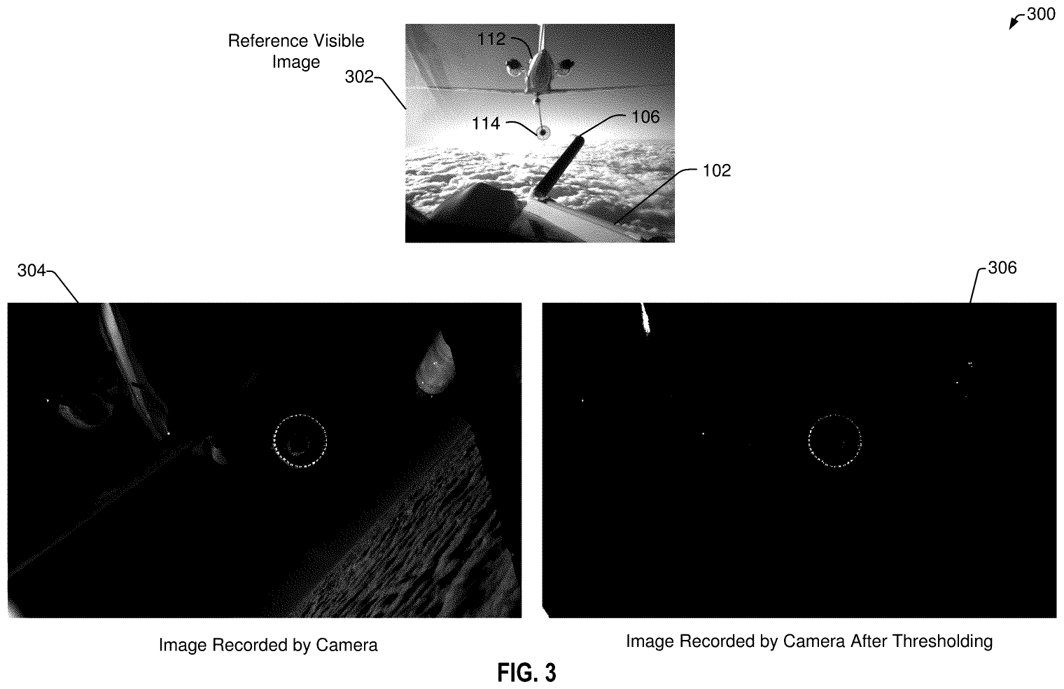

The vision processor 204 includes one or more processors, processor systems, CPUs, GPUs, DSPs, and/or other hardware or circuitry, such as field-programmable gate arrays (FPGAs) or application-specific integrated circuits (ASICs), that are configured to process the image data from the camera 202 (and optionally other data from other sensors) to identify and track an object, such as a drogue (e.g., 114) and/or another aircraft or spacecraft, within a series of images represented by the image data. For example, the vision processor 204 can include or correspond to the vision processor 108. As described further herein with reference to FIGS. 3-6, the vision processor 204 can perform image data processing/image processing to detect or identify a location or an estimated location of the drogue 114, or a portion thereof. Additionally, or alternatively, the vision processor 204 can process the image data and/or other data to identify, track, and/or determine a location or estimated location of a connector of the other aircraft, using other techniques. In implementations in which the vision processor 204 determines multiple locations or estimated locations, other derived values, and/or other processed image data, each such value or estimation may be associated with a confidence score generated by the vision processor 204. The vision processor 204 provides the estimates, derived values, and/or processed image data, and optionally the confidence scores, to the guidance processor 208 for further processing and, optionally, to the data storage 212. Additionally, or alternatively, the data storage 212 may be configured to store dimension information associated with the drogue 114, such as a size of the drogue 114 (e.g., an aerial refueling basket). For example, the size may be a radius of the drogue 114.

The guidance processor 208, the EGI 206, or both, may include or correspond to the additional processor(s) 111. The guidance processor 208 includes one or more processors, processor systems, CPUs, GPUs, DSPs, and/or other hardware or circuitry, such as FPGAs or ASICs, that are configured to process the output of the vision processor 204 and optional GPS and INS data received from the EGI 206 to determine one or more maneuvers to be performed by the aircraft on which the system 200 is onboard to cause the aircraft to mate a connector (e.g., the probe 106) with a connector (e.g., the drogue 114) of the other aircraft. The maneuvers can include navigation directions for the aircraft, movements for a probe or other arm or boom that controls the connector for the aircraft, engine control instructions, other maneuver-related information, or a combination thereof, that when executed by the auto pilot system 210, cause the aircraft to mate the connector to the corresponding connector of the other aircraft, such as during an aerial refueling operation or a docking operation between spacecraft. As a non-limiting example, the guidance processor 208 may output instructions to the auto pilot system 210 to cause the first aircraft 102 to mate the probe 106 with the drogue 114 of the second aircraft 112.

In implementations that include the data storage 212, the vision processor 204 may be configured to provide the various output (e.g., a location, an estimated location, detection information, identification information, tracking information, processed image data, etc.) to the data storage 212 for storage on the aircraft and/or transmission to another system or device. For example, the data storage 212 can include network or cloud storage that is wireless connected to the system 200 at various times. The output data from the vision processor 204 (the “vision output data”) may be used to train one or more artificial intelligence (AI) or machine learning (ML) models to automatically perform operations associated with the vision processor 204, the guidance processor 208, or a combination thereof. To illustrate, the vision output data can be provided as training data to an autonomous agent (e.g., an AI or ML model) to train the autonomous agent to estimate a location of the drogue 114, or a portion thereof, based on input thermal imaging data.

In a particular aspect, image data (or features extracted therefrom) can be labeled with corresponding location data, estimated location data, or a combination thereof, to train the autonomous agent to estimate a location of the drogue 114 or a portion thereof based on non-labeled image data received as an input. In another aspect, the image data (or features extracted therefrom) can be labeled with one or more maneuvers output by the guidance processor 208 to train the autonomous agent to, responsive to receiving unlabeled image data, output maneuver instructions to cause the aircraft to mate the connector with the connector of the other aircraft. In a particular implementation, the trained autonomous agent includes or corresponds to a neural network. As an example, the neural network of the trained autonomous agent is trained using one or more reinforcement learning techniques. To illustrate, during a training phase, the reinforcement learning techniques may train the neural network based in part on a reward that is determined by comparing a proposed maneuver output by the neural network to an optimum or target maneuver in particular circumstances. In this context, the optimum or target maneuver may include, for example, a shortest or least cost maneuver to mate the connectors of the aircrafts; a maneuver that mimics a maneuver performed by one or more skilled human operators under similar circumstances; a maneuver that satisfies a set of safety conditions, such as not causing any undesired contact between portions of the aircrafts; a maneuver that corresponds to maneuvering characteristics specified during or before training; or a combination thereof. As another example, during a training phase, the reinforcement learning techniques may train the neural network based in part on a reward that is determined by comparing a location or estimated location output by the neural network to a measured location or a measured position of the drogue 114 (or a portion thereof) depicted in the image and based on the image data.

In some implementations, the system 200 may include a display (not shown). The display may be coupled to the camera 202, the vision processor 204, the guidance processor 208, the auto pilot system 210, or a combination thereof. The display is configured to display one or more images, a representation of one or more operations performed by the vision processor 204, one or more operations performed by guidance processor 208, one or more operations performed by the auto pilot system 210, or a combination thereof.

Referring to FIGS. 3-6, examples of techniques to process one or more images and/or identify a location or an estimated location of a portion of a drogue according to one or more aspects of the present disclosure are described. The techniques described with reference to FIGS. 3-6 may be initiated, performed, or controlled by one or more processors executing instructions, or by circuitry configured to cause performance of one or more operations, such as resides within the imaging sensor 104, the vision processor 108, the camera 202, the vision processor 204, a vision system 820, a vision system 932, one or more processors 1020, or a combination thereof. It is also noted that a technique described with reference to one of FIGS. 3-6 may be combined with another technique described with reference to another of FIGS. 3-6.

FIG. 3 depicts an example of a technique 300 to generate a thresholded image according to one or more aspects of the present disclosure. The technique 300 is described with reference to a reference visible image 302. The reference visible image 302 can be captured by an imaging sensor, e.g., a sensor, such as the one or more sensors 110. The reference visible image 302 includes the first aircraft 102, the probe 106, the second aircraft 112, and the drogue 114.

The technique 300 includes receiving an image 304 (e.g., image data) captured by an imaging sensor. For example, the image 304 can be received by the vision processor 108 or 204. The imaging sensor can include or correspond to the imaging sensor 104 or the camera 202. The imaging sensor can capture the image 304 during illumination of a light source, such as the light source 194 or the light source 203, and via the filter 205. It is noted that the reflective markers 180 of the drogue 114 are depicted in the image 304.

The technique 300 also includes generating a thresholded image 306. For example, the imaging sensor 104 or the vision processor 204 can perform a thresholding operation on the image 304 to generate the thresholded image 306. In some implementations, the thresholding operation can be performed to convert a grayscale image, such as the image 304, into a binary image. It is noted that the reflective markers 180 of the drogue 114 are depicted in the thresholded image 306. In addition to the reflective markers 180, the thresholded image 306 includes a minimal amount of interference, such as solar interference and/or reflections of solar interference.

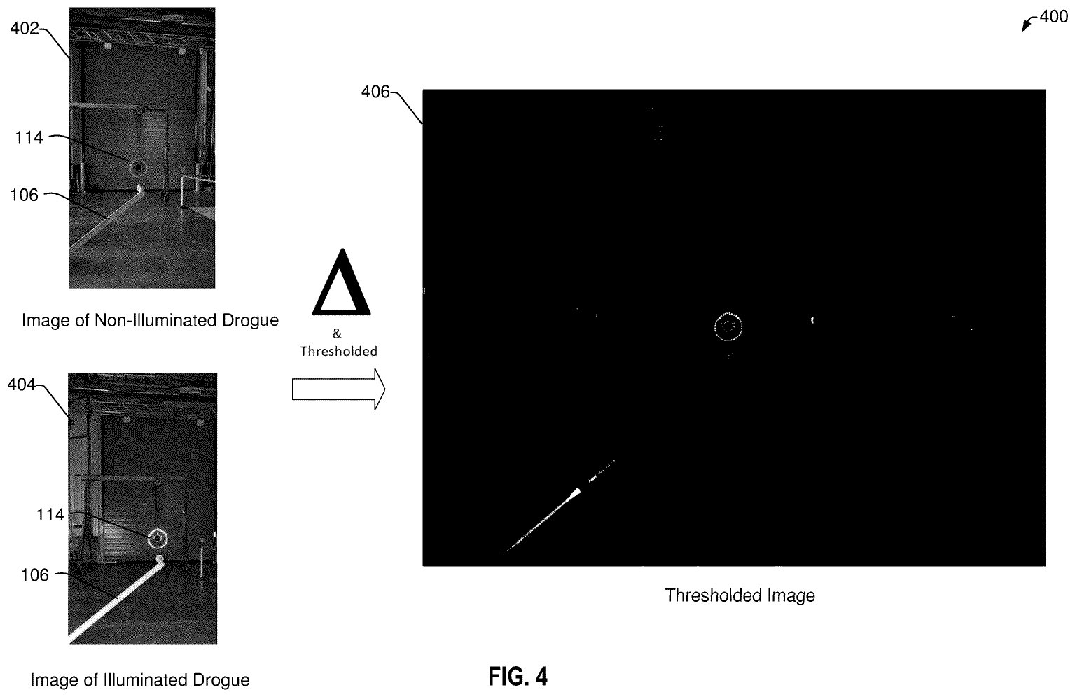

FIG. 4 depicts another example of a technique 400 to generate a thresholded image according to one or more aspects of the present disclosure. The technique 400 provides an example of a correlated double sampling technique to generate the thresholded image. In this example, the correlated double sampling technique includes a technique in which a first image is subtracted from a second image to generate a difference image. The difference image can be used to further exclude artifacts arising from ambient illumination (e.g., the sun or any light sources other than the above-described light source 194 or 203), and better identify a change in a condition and/or noise between the two images.

The technique 400 includes receiving a first image 402 (e.g., image data) captured by an imaging sensor. For example, the first image 402 can be received by a vision processor, such the vision processor 108 or 204. The imaging sensor can include or correspond to the imaging sensor 104 or the camera 202. The first image 402 depicts the drogue 114 and the probe 106. The imaging sensor can capture the first image 402 while a light source, such as light source 194 or 203, is deactivated (e.g., non-illuminated) and not projecting light. In some implementations, the imaging sensor captures the first image 402 via the filter 205. It is noted that the reflective markers 180 of the drogue 114 do not appear illuminated in the first image 402.

The technique 400 includes receiving a second image 404 (e.g., image data) captured by the imaging sensor. For example, the second image 404 can be received by a vision processor, such the vision processor 108 or 204. In some implementations, the first image 402 and the second image 404 are sequential images in a series of images. In some implementations, the second image is captured before the first image in the series of images. The second image 404 depicts the drogue 114 and the probe 106. The imaging sensor can capture the second image 404 while a light source, such as light source 194 or 203, is activated (e.g., illuminated) and projecting light. Accordingly, the reflective markers 180 of the drogue 114 appear illuminated in the second image 404. In some implementations, the imaging sensor captures the second image 404 via the filter 205.

After receiving the first image 402 and the second image 404, a difference image (not shown) is generated based on the first image 402 and the second image 404. For example, the vision processor can perform a correlated double sampling operation to generate the difference image. The correlated double sampling operation can remove ambient artifacts, reduce or eliminate solar interference, improve signal contrast, or a combination thereof, in the difference image.

The technique 400 also includes generating a thresholded image 406. For example, the vision processor can perform a thresholding operation on the difference image to generate the thresholded image 406. In some implementations, the thresholding operation can be performed to convert a grayscale image, such as the difference image, into a binary image. It is noted that the reflective markers 180 of the drogue 114 are depicted in the thresholded image 406. In addition to the reflective markers 180, the thresholded image 406 includes a minimal amount of interference, such as solar interference, reflections of solar interference, and/or other reflective markers not coupled to or attached to the drogue 114.

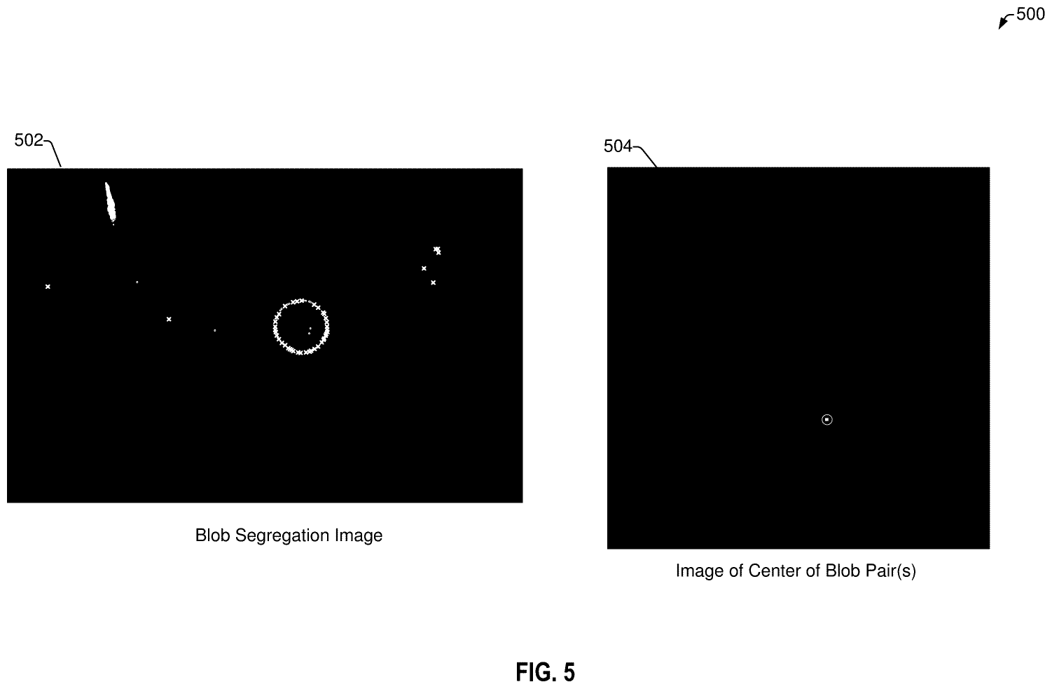

FIG. 5 depicts an example of a technique 500 to identify a location of a drogue using active illumination according to one or more aspects of the present disclosure. The technique 500 can be performed by a vision processor, such as the vision processor 108 or 204.

The technique 500 includes performing a blob segmentation operation to generate a blob segmentation image 502. For example, the blob segmentation operation can be performed on a thresholded image, such as the thresholded image 306 or 406. Additionally, in some implementations, the blob segmentation operation is configured to, for at least one identified blob, generate characteristic information that includes or indicates a blob center (e.g., in a horizontal direction, a vertical direction, or both), a score or confidence weight, a count of a number of pixels in the blob, a blob bounding box dimension (e.g., a width, a height, a radius, or a combination thereof), a blob aspect ratio, a blob density, a blob de-center (e.g., a distance form a highest pixel in the blob to a center of mass), an angle between the center of mass and a further blob extent, or a combination thereof, as illustrative, non-limiting examples. In some implementations, the blob segmentation operation can determine a location of each identified blob.

The technique 500 includes determining a location (e.g., a center) of a set of blobs identified included in the blob segmentation image 502. For example, the vision processor can identify a portion of the blob segmentation image 502 that includes multiple blobs (e.g., a cluster of blobs). The vision processor can perform one or more operations to determine a center of the multiple blobs. To illustrate, an image 504 depicts a center of multiple blobs (from the blob segmentation image 502) that correspond to the reflective markers 180 of the drogue 114.

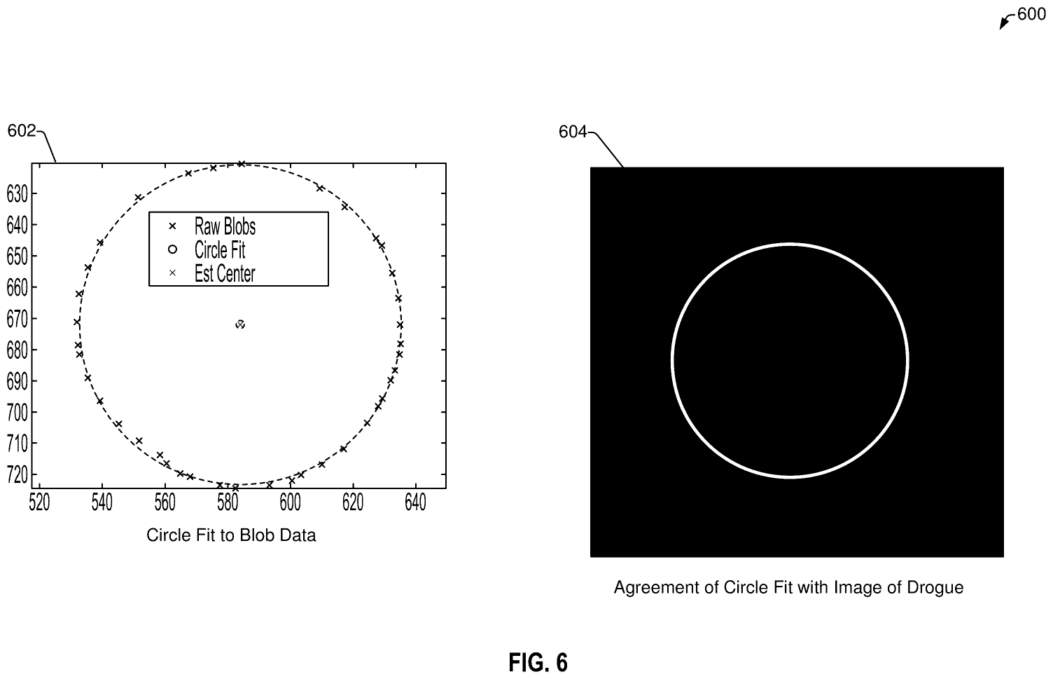

FIG. 6 depicts an example of a technique 600 to use a model to identify a location of a drogue using active illumination according to one or more aspects of the present disclosure. In some implementations, the model can include or correspond to the drogue 114. For example, the model can be based on a shape of the canopy 168 of the drogue 114. Additionally, or alternatively, the model can have a circular shape, an elliptical shape, or another shape, based on a pose of the drogue 114. For example, a model of a front view of the drogue 114 can be circular and a model of a view that is 45 degrees from the front view of the drogue 114 can be elliptical.

Referring to an image 602, a model (e.g., a circle) is fit to location data of multiple blobs. For example, the location data of the multiple blobs can be determined by the vision processor, such as the vision processor 108 or 204. The location data of the multiple blobs can be determined based on the blob segmentation operation described with reference to the blob segmentation image 502. In some implementations, the model can be generated based on an estimated center, such as the center of the set of blobs as determined and shown with reference to an image 504. An image 604 depicts the model that is fit to the multiple blobs overlaid on an image of the drogue 114 to illustrate how well fit model matches the drogue 114.

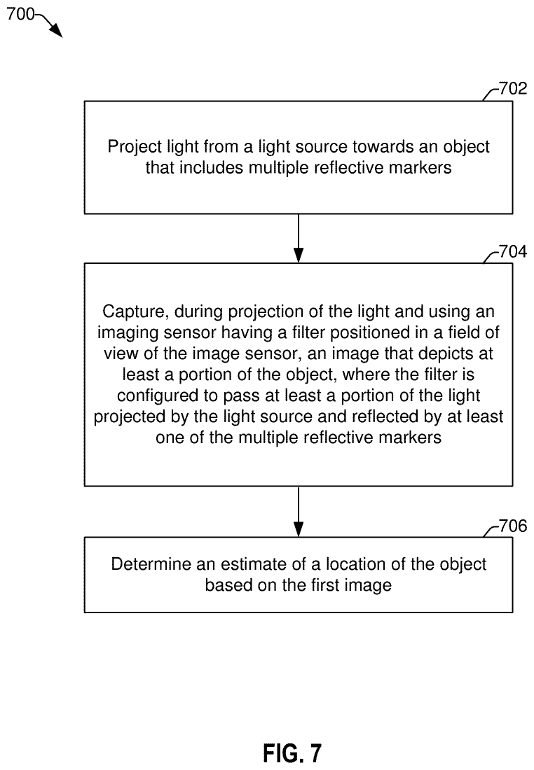

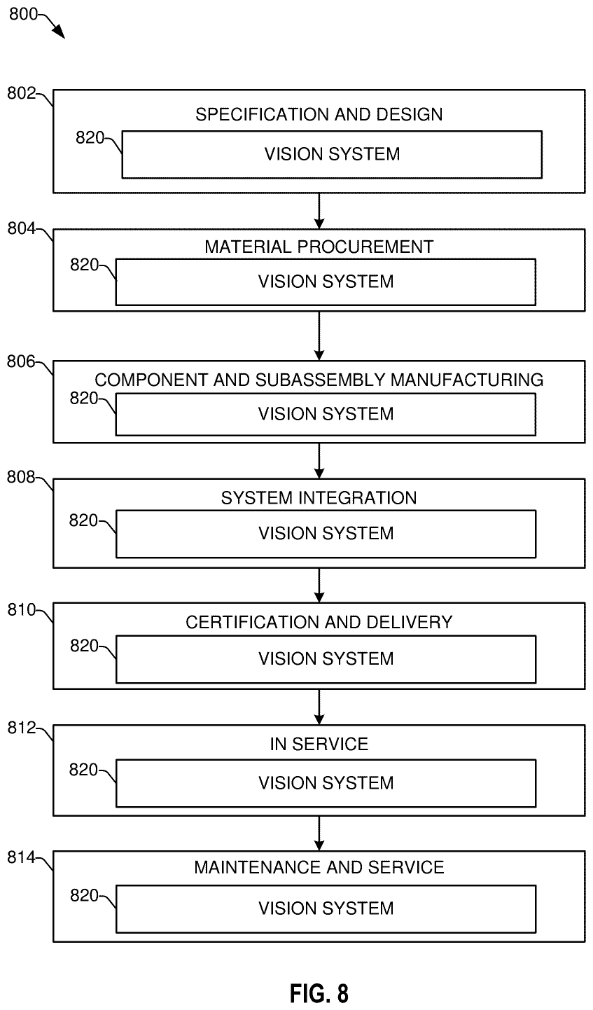

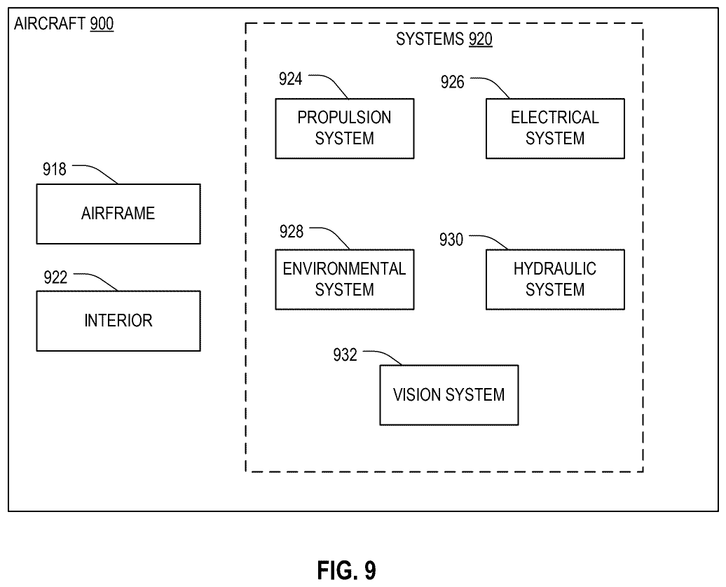

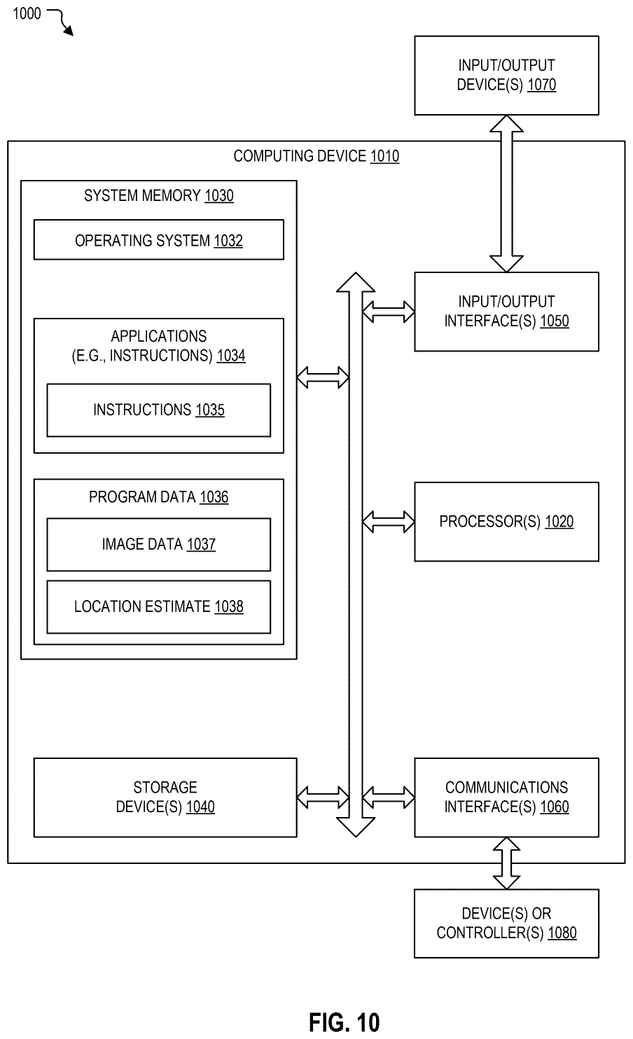

FIG. 7 is a flowchart that illustrates an example of a method 700 of identifying a location of an object using active illumination according to one or more aspects of the present disclosure. The method 700 can be initiated, performed, or controlled by one or more processors executing instructions, or by circuitry configured to cause performance of one or more operations, such as resides within a vision system (e.g., the imaging sensor 104, the camera 202, the light source 203, and/or the filter 205), the vision processor 108 of FIG. 1A, the vision processor 204 of FIG. 2, a vision system 820 of FIG. 8, a vision system 932 of FIG. 9, one or more processors 1020 of FIG. 10, or a combination thereof. The one or more processors may be included in a device, such as the first aircraft 102. In some implementations, the device includes an autonomous or semi-autonomous air or space vehicle.

In some implementations, the method 700 includes, at block 702, projecting light from a light source towards an object that includes multiple reflective markers. For example, the light can be projected by the light source 194 or the light source 203. The light source can include a high-intensity light source, a high-speed light source, a narrow-band light source, or a combination thereof. For example, the light source can include multiple infrared light emitting diodes (LEDs). In some implementations, the light source receives a signal from the imaging sensor 104, the vision processor 108, the camera 202, or the vision processor 204, and projects the light responsive to the signal.

The object can include or correspond to the drogue 114. The multiple reflective markers can include or correspond to the reflective markers 180. The object can be coupled to an aircraft via a hose. To illustrate, the drogue 114 can be coupled to the second aircraft 112 via the hose 116. The object includes a socket (e.g., the internal passage 170) configured to be coupled to a probe, such as the probe 106 of the first aircraft 102. The multiple reflective markers (e.g., 180) can be positioned on the canopy 168 of the object, the reception coupling 160 of the object, one or more structures 166 of the object, or a combination thereof. In some implementations, at least one reflective marker of the multiple reflective markers includes a retroreflector.

The method 700 also includes, at block 704, capturing, during projection of the light and using an imaging sensor having a filter positioned in a field of view of the imaging sensor, an image that depicts at least a portion of the object. For example, the image can be captured by the imaging sensor 104 or the camera 202. Capturing the image can include operating a shutter (e.g., a mechanical shutter or an electrical shutter) of the imaging sensor (e.g., a camera). Additionally, projection of the light by the light source can be time-correlated with operation of the shutter. To illustrate, the method 700 can include activating the light source concurrently with initiation of an image capture operation by the imaging sensor to capture the image.

The filter can include or correspond to the filter 205. The filter is configured to pass at least a portion of the light that is projected by the light source and reflected by at least one of the multiple reflective makers of the multiple reflective markers. Additionally, or alternatively, the filter is configured to block light other than the light projected by the light source.

In some implementations, to capture the image, the imaging sensor generates image data and provides the image data to a vision processor, such as the vision processor 108 or 204. Additionally, or alternatively, the image data can be stored at a memory, such as the data storage 212.

The method 700 includes, at block 706, determining an estimate of a location (e.g., the center) of the object based on the first image. For example, a vision processor, such as the vision processor 108 or 204, may be configured to determine the estimate of the location of the object. The location of the object can be a center of the object, such as a center of the canopy 168 or a center of a socket (e.g., internal passage 170). In some implementations, the method 700 includes identifying and/or tracking the object based on the estimate of the location.

To determine the estimate of the location of the object, the vision processor can process the image. In some implementations, the imaging system (e.g., the imaging sensor 104, the camera 202, the light source 203, and/or the filter 205), the processing of the image by the vision processor, or both, is configured to minimize solar interference in the image. To process the image, the method 700 can include performing a thresholding operation based on the image to generate a thresholded image.

In some implementations, the thresholded image is generated by performing the thresholding operation on a first image. In other implementations, the thresholded image is generated based on the image (i.e., a first image) and a second image. To illustrate, the method 700 can include initiating a second image capture operation by the imaging sensor to capture a second image. The second image is captured while the light source is deactivated. In some implementations, the method 700 includes initiating a series of image capture operations (by the imaging sensor) that alternate between: a first image capture operation to capture an illuminated image while the light source is activated; and a second image capture operation to capture a non-illuminated while the light source is deactivated. The method 700 can then include performing a correlation operation based on the first image and the second image to generate a difference image. It is noted that the order of the first and second images in method 700 can be reversed, such that the second image is captured prior to the first image being captured. A thresholding operation can then be performed on the difference image to generate a thresholded image.

In some implementations, the method 700 includes performing a blob segregation operation on the thresholded image to identify multiple blobs. Additionally, the method 700 can include, based on the multiple blobs, identifying a center of a set of blobs of the multiple blobs, fitting a model to the set of blobs, or a combination thereof. In some implementations, the estimate of the location of the object is based on or corresponds to the center of the set of blobs, the model fit to the set of blobs, or a combination thereof. Additionally, or alternatively, the method 700 can include generating a score associated with the estimate of the location of the object. The score can be determined based on how closely the set of blobs fit the model, a difference between the calculated center of the set of blobs and a center of the model, a number of blobs, or a combination thereof, as illustrative, non-limiting examples.

In some implementations, the method 700 includes adjusting an exposure time of the imaging sensor, sensor gain, an illumination intensity of the light source, a synchronization between the imagine sensor and the light source, or a combination thereof, based on the location of the object. For example, the vision processor 108 or 204 can adjust the exposure time, sensor gain, the illumination intensity, or a synchronization based on processing the image a result of detection of the location of the object. The adjustment can be implemented to improve another detection result of the location of the object.

In some implementations, the method 700 includes determining one or more candidate locations of the object, where each candidate corresponds to a different estimate. The method 700 can include determining a score for each candidate location. The method 700 can include selecting a candidate location for use as the estimate of the center of the object. In some implementations, the method 700 determines multiple candidates of the estimate and selects one or more candidates as the estimate of the center.

In some implementations, the method 700 includes controlling an autonomous aerial refueling operation based on the estimate of the center. For example, the auto pilot system 210 can be configured to control the autonomous aerial refueling operation. During the autonomous aerial refueling operation, the probe is coupled to the object and, when coupled to the object, receives fuel via the object.

The method described above with reference to FIG. 7 can be implemented to realize one or more of the technical advantages described herein. For example, the method 700 can enable performing image-based detection or identification, such as detection or identification of a location of an object in images. To illustrate, the method 700 can enable detection of the object (e.g., a refueling basket) based on simultaneously triggered activation of the light source and an image capture operation by the imaging sensor to capture an image. The image is then processed to minimize solar interference in the image and to detect the location of the object in the image. The method 700 can also enable detection of a location of a socket (configured to be coupled to a probe) of the object. Additionally, the method 700 can enable probe and aerial refueling of an autonomous or semi-autonomous aircraft. For example, detection of a candidate location of an objectcan be used to identify and verify a location of the object, which can then be tracked and used to perform an aerial refueling of an autonomous or semi-autonomous aircraft.

Referring to FIG. 8, a flowchart illustrative of an example of a life cycle of an aircraft that includes a vision system configured to identify a location of an object (e.g., a drogue) using active illumination is shown and designated 800. For example, the aircraft can include or correspond to the first aircraft 102. The vision system can include or correspond to the vision processor 108 or 204, and the object may include or correspond to drogue 114.

During pre-production, the exemplary method 800 includes, at 802, specification and design of an aircraft, such as the first aircraft 102 described with reference to FIGS. 1A-H. During specification and design of the aircraft, the method 800 can include specification and design of a vision system 820 that is configured to identify the location of the object. The vision system 820 may include one or more components of the system 100 or 200. In some implementations, the vision system 820 includes or corresponds to the imaging sensor 104, the light source 194, the camera 202, the light source 203, the filter 205, the vision processor 108, the vision processor 204, a vision system 932 of FIG. 9, one or more processors 1020 of FIG. 10, or a combination thereof. At 804, the method 800 includes material procurement, which can include procuring materials for the vision system 820.

During production, the method 800 includes, at 806, component and subassembly manufacturing and, at 808, system integration of the aircraft. For example, the method 800 can include component and subassembly manufacturing of the vision system 820 and system integration of the vision system 820. At 810, the method 800 includes certification and delivery of the aircraft and, at 812, placing the aircraft in service. Certification and delivery can include certification of the vision system 820 to place the vision system 820 in service. While in service by a customer, the aircraft can be scheduled for routine maintenance and service (which can also include modification, reconfiguration, refurbishment, and so on). At 814, the method 800 includes performing maintenance and service on the aircraft, which can include performing maintenance and service on the vision system 820.

Each of the processes of the method 800 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

Aspects of the disclosure can be described in the context of an example of a vehicle. A particular example of a vehicle is an aircraft 900 as shown in FIG. 9. For example, the aircraft 900 may include or correspond to the first aircraft 102. The aircraft 900 can be a drone aircraft or any type of autonomous or semi-autonomous aircraft or spacecraft. In the example of FIG. 9, the aircraft 900 includes an airframe 918 with a plurality of systems 920 and an interior 922. Examples of the plurality of systems 920 include one or more of a propulsion system 924, an electrical system 926, an environmental system 928, a hydraulic system 930, and a vision system 932. Any number of other systems can be included and/or one or more of the systems depicted in FIG. 9 may be omitted. In the example of FIG. 9, the vision system 932 is configured to provide image-based identification (e.g., of a location of an object) functionality using active illumination and can include or correspond to the system 100, the imaging sensor 104, the vision processor 108, the light source 194, the system 200, the camera 202, the light source 203, the vision processor 204, the filter 205, the vision system 820, or any combination thereof.

FIG. 10 is a block diagram of a computing environment 1000 including a computing device 1010 configured to support aspects of computer-implemented methods and computer-executable program instructions (or code) according to the present disclosure. For example, the computing device 1010, or portions thereof, is configured to execute instructions to initiate, perform, or control one or more operations described with reference to FIG. 1A-H or 2-9.

The computing device 1010 includes one or more processors 1020. The processor(s) 1020 are configured to communicate with system memory 1030, one or more storage devices 1040, one or more input/output interfaces 1050, one or more communications interfaces 1060, or any combination thereof. The system memory 1030 includes volatile memory devices (e.g., random access memory (RAM) devices), nonvolatile memory devices (e.g., read-only memory (ROM) devices, programmable read-only memory, and flash memory), or both. The system memory 1030 stores an operating system 1032, which can include a basic input/output system for booting the computing device 1010 as well as a full operating system to enable the computing device 1010 to interact with users, other programs, and other devices. The system memory 1030 stores system (program) data 1036, such as image data 1037, a location estimate 1038 (e.g., of an object), or a combination thereof. The image data 1037 can include or correspond to thermal image data generated by the imaging sensor 104 or the camera 202. The location estimate 1038 can include or correspond to an estimated location or center of the object (e.g., a drogue 114) generated by the vision processor 108 or 204, or the vision system 820.

The system memory 1030 includes one or more applications 1034 (e.g., sets of instructions) executable by the processor(s) 1020. As an example, the one or more applications 1034 include instructions executable by the processor(s) 1020 to initiate, control, or perform one or more operations described with reference to FIG. 1A-H or 2-10. To illustrate, the one or more applications 1034 include instructions 1035 executable by the processor(s) 1020 to initiate, control, or perform one or more operations described with reference to the vision processor 108 or 204, or the vision system 820.

In a particular implementation, the system memory 1030 includes a non-transitory, computer readable medium storing the instructions 1035 that, when executed by the processor(s) 1020, cause the processor(s) 1020 to initiate, perform, or control operations to perform thermal image-based identification (e.g., of a location of an object) functionality to enable or support one or more operations of an autonomous or semi-autonomous vehicle. For example, the operations may include one or more operations as described with reference to at least FIG. 7.

The one or more storage devices 1040 include nonvolatile storage devices, such as magnetic disks, optical disks, or flash memory devices. In a particular example, the storage devices 1040 include both removable and non-removable memory devices. The storage devices 1040 are configured to store an operating system, images of operating systems, applications (e.g., one or more of the applications 1034), and program data (e.g., the system program data 1036). In a particular aspect, the system memory 1030, the storage devices 1040, or both, include tangible computer-readable media. In a particular aspect, one or more of the storage devices 1040 are external to the computing device 1010.

The one or more input/output interfaces 1050 enable the computing device 1010 to communicate with one or more input/output devices 1070 to facilitate user interaction. For example, the one or more input/output interfaces 1050 can include a display interface, an input interface, or both. For example, the input/output interface 1050 is adapted to receive input from a user, to receive input from another computing device, or a combination thereof. In some implementations, the input/output interface 1050 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 1070 includes one or more user interface devices and displays, including some combination of buttons, keyboards, pointing devices, displays, speakers, microphones, touch screens, and other devices.

The processor(s) 1020 are configured to communicate with devices or controllers 1080 via the one or more communications interfaces 1060. For example, the one or more communications interfaces 1060 can include a network interface. The devices or controllers 1080 can include, for example, a controller for the probe 106, one or more other devices, or any combination thereof.

In some implementations, a non-transitory, computer readable medium stores instructions that, when executed by one or more processors, cause the one or more processors to initiate, perform, or control operations to perform part or all of the functionality described above. For example, the instructions can be executable to implement one or more of the operations or methods of FIG. 1A-H or 2-10. In some implementations, part or all of one or more of the operations or methods of FIG. 1A-H or 2-10 can be implemented by one or more processors (e.g., one or more central processing units (CPUs), one or more graphics processing units (GPUs), one or more digital signal processors (DSPs), one or more field-programmable gate arrays (FPGAs), or one or more application-specific integrated circuits (ASICs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Aspects of the disclosure are described further with reference to the following set of interrelated examples:

According to Example 1, a device includes an imaging system and a vision processor. The imaging system includes an imaging sensor, a light source, and a filter. The imaging sensor is configured to generate one or more images that each depict at least a portion of an object that includes multiple reflective markers. The light source is configured to project light. The filter is positioned in a field of view of the imaging sensor and configured to pass at least a portion of the light projected by the light source and reflected by the multiple reflective markers. The vision processor is configured to: receive a first image of the one or more images, the first image captured during projection of the light from the light source; and determine an estimate of a location of the object based on the first image.

Example 2 includes the device of Example 1, where the vision processor is further configured to process the first image, and where the imaging system, the processing of the first image by the vision processor, or both, is configured to minimize solar interference in the first image.

Example 3 includes the device of Example 1 or Example 2, where the imaging sensor includes a camera, where the light source includes a high-intensity light source, a high-speed light source, a narrow-band light source, or a combination thereof, and where projection of the light by the light source is time-correlated with operation of a mechanical shutter or an electrical shutter of the camera.

Example 4 includes the device of any one of Examples 1-3, where the light source includes multiple infrared light emitting diodes (LEDs), where the filter is configured block light other than the light projected by the light source and to pass at least a portion of the light projected by the light source, where the multiple reflective markers are positioned on a canopy of the object, and where at least one reflective marker of the multiple reflective markers includes a retroreflector.

Example 5 includes the device of any one of Examples 1-4, where the vision processor is further configured to perform a thresholding operation based on the first image to generate a thresholded image.

Example 6 includes the device of any one of Examples 1-4, where the vision processor is further configured to: activate the light source concurrently with initiation of a first image capture operation by the imaging sensor to capture the first image; initiate a second image capture operation by the imaging sensor to capture a second image of the one or more images, the second image captured while the light source is deactivated; and receive the second image, and where the first image is captured prior or subsequent to the second image being captured.

Example 7 includes the device of Example 6, where the vision processor is further configured to: perform a correlation operation based on the first image and the second image to generate a difference image; and perform a thresholding operation on the difference image to generate a thresholded image.

Example 8 includes the device of Example 5 or Example 7, where the vision processor is further configured to perform a blob segregation operation on the thresholded image to identify multiple blobs.

Example 9 includes the device of Example 8, where the vision processor is further configured to, based on the multiple blobs: identify a center of a set of blobs of the multiple blobs; fit a model to the set of blobs; or a combination thereof; and where the location of the object is based on the center of the set of blobs, the model; or a combination thereof.

Example 10 includes the device of any one of Examples 1-9, where the vision processor is further configured to: generate a score associated with the location of the object; or adjust an exposure time of the imaging sensor, a gain of the imaging sensor, an illumination intensity of the light source, a synchronization between the imagine sensor and the light source, or a combination thereof.

According to Example 11, a method includes performing one or more operations of the imaging system and/or the vision processor of the device of any one of Examples 1-10.

According to Example 12, a non-transitory, computer-readable medium stores instructions that, when executed by one or more processors, cause the one or more processors to perform operations including the method of Example 11.

According to Example 13, a vehicle includes the device of any one of Examples 1-10.

Example 14 includes the vehicle of Example 13, where the vehicle includes an aircraft.

Example 15 includes the vehicle of Example 14, where the aircraft includes an autonomous air vehicle.

According to Example 16, a method includes: projecting light from a light source towards an object that includes multiple reflective markers; capturing, during projection of the light and using an imaging sensor having a filter positioned in a field of view of the imaging sensor, an image that depicts at least a portion of the object, where the filter is configured to pass at least a portion of the light projected by the light source and reflected by at least one of the multiple reflective markers; and determining an estimate of a location of the object based on the first image.

Example 17 includes the method of Example 16, and the method further includes performing a thresholding operation based on the image to generate a thresholded image.

Example 18 includes the method of Example 16 or Example 17, and the method further includes: activating the light source concurrently with initiation of a first image capture operation by the imaging sensor to capture the image; initiating a second image capture operation by the imaging sensor to capture another image, the other image captured while the light source is deactivated; and receiving the other image.

Example 19 includes the method of Example 18, and the method further includes: performing a correlation operation based on the image and the other image to generate a difference image; and performing a thresholding operation on the difference image to generate a thresholded image.

Example 20 includes the method of Example 19, and the method further includes performing a blob segregation operation on the thresholded image to identify multiple blobs.

Example 21 includes the method Example 20, and the method further includes: identifying a center of a set of blobs of the multiple blobs, fitting a model to the set of blobs, or a combination thereof; and where the location of the object is based on the center of the set of blobs, the model, or a combination thereof.

Example 22 includes the method of any one of Examples 16-21, and the method further includes generating a score associated with the location of the object.

Example 23 includes the method of any one of Examples 16-22, and the method further includes adjusting an exposure time of the imaging sensor, a gain of the imaging sensor, an illumination intensity of the light source, a synchronization between the imaging sensor and the light source, or a combination thereof.

According to Example 24, a device includes a vision processor configured to: receive an image captured by an imaging sensor during projection of the light from a light source towards an object that includes multiple reflective markers, wherein the image depicts at least a portion of the object, wherein the imaging sensor has a filter positioned in a field of view of the imaging sensor, and wherein the filter is configured to pass at least a portion of the light projected by the light source and reflected by at least one of the multiple reflective markers; and determine an estimate of a location of the object based on the image.

Example 25 includes the device of Example 24, where the device includes a vehicle.

Example 26 includes the device Example 25, where the vehicle includes an aircraft.

Example 27 includes the device of Example 26, where the aircraft includes an autonomous air vehicle.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

What is claimed is:

1. A device comprising:
an imaging system including:
an imaging sensor configured to generate one or more images that each depict at least a portion of an object that includes multiple reflective markers;
a light source configured to project light; and
a filter positioned in a field of view of the imaging sensor and configured to pass at least a portion of the light projected by the light source and reflected by the multiple reflective markers; and
a vision processor configured to:
receive a first image of the one or more images, the first image captured during projection of the light from the light source; and
determine an estimate of a location of the object based on the first image.

2. The device of claim 1, wherein:
the vision processor is further configured to process the first image; and
the imaging system, the processing of the first image by the vision processor, or both, is configured to minimize solar interference in the first image.

3. The device of claim 1, wherein:
the imaging sensor includes a camera;
the light source includes a high-intensity light source, a high-speed light source, a narrow-band light source, or a combination thereof; and
the projection of the light by the light source is time-correlated with operation of a mechanical shutter or an electrical shutter of the camera.

4. The device of claim 1, wherein:
the light source includes multiple infrared light emitting diodes (LEDs);
the filter is configured block light other than the light projected by the light source and to pass at least a portion of the light projected by the light source;
the multiple reflective markers are positioned on a canopy of the object; and
at least one reflective marker of the multiple reflective markers includes a retroreflector.

5. The device of claim 1, wherein the vision processor is further configured to:
perform a thresholding operation based on the first image to generate a thresholded image.

6. The device of claim 1, wherein:
the vision processor is further configured to:
activate the light source concurrently with initiation of a first image capture operation by the imaging sensor to capture the first image;
initiate a second image capture operation by the imaging sensor to capture a second image of the one or more images, the second image captured while the light source is deactivated; and
receive the second image; and
the first image is captured prior or subsequent to the second image being captured.

7. The device of claim 6, wherein the vision processor is further configured to:
perform a correlation operation based on the first image and the second image to generate a difference image; and
perform a thresholding operation on the difference image to generate a thresholded image.

8. The device of claim 7, wherein the vision processor is further configured to:
perform a blob segregation operation on the thresholded image to identify multiple blobs.

9. The device of claim 8, wherein:
the vision processor is further configured to, based on the multiple blobs:
identify a center of a set of blobs of the multiple blobs;
fit a model to the set of blobs; or
a combination thereof; and
the location of the object is based on the center of the set of blobs, the model, or a combination thereof.

10. The device of claim 1, wherein the vision processor is further configured to:
generate a score associated with the location of the object; or
adjust an exposure time of the imaging sensor, a gain of the imaging sensor, an illumination intensity of the light source, a synchronization between the imaging sensor and the light source, or a combination thereof.

11. A method comprising:
projecting light from a light source towards an object that includes multiple reflective markers;
capturing, during projection of the light and using an imaging sensor having a filter positioned in a field of view of the imaging sensor, an image that depicts at least a portion of the object, wherein the filter is configured to pass at least a portion of the light projected by the light source and reflected by at least one of the multiple reflective markers; and
determining an estimate of a location of the object based on the image.

12. The method of claim 11, further comprising performing a thresholding operation based on the image to generate a thresholded image.

13. The method of claim 11, further comprising:
activating the light source concurrently with initiation of a first image capture operation by the imaging sensor to capture the image;
initiating a second image capture operation by the imaging sensor to capture another image, the other image captured while the light source is deactivated; and
receiving the other image.

14. The method of claim 13, further comprising:
performing a correlation operation based on the image and the other image to generate a difference image; and
performing a thresholding operation on the difference image to generate a thresholded image.

15. The method of claim 14, further comprising performing a blob segregation operation on the thresholded image to identify multiple blobs.

16. The method of claim 15, further comprising:
identifying a center of a set of blobs of the multiple blobs, fitting a model to the set of blobs, or a combination thereof; and
wherein the location of the object is based on the center of the set of blobs, the model, or a combination thereof.

17. A device comprising:
a vision processor configured to:
receive an image captured by an imaging sensor during projection of a light from a light source towards an object that includes multiple reflective markers, wherein the image depicts at least a portion of the object, wherein the imaging sensor has a filter positioned in a field of view of the imaging sensor, and wherein the filter is configured to pass at least a portion of the light projected by the light source and reflected by at least one of the multiple reflective markers; and
determine an estimate of a location of the object based on the image.

18. The device of claim 17, wherein the device includes a vehicle.

19. The device of claim 18, wherein the vehicle includes an aircraft.

20. The device of claim 19, wherein the aircraft includes an autonomous air vehicle.
